(19) United States
(12) Patent Application Publication
(10) Pub. No.: US 2021/0130937 A1
(43) Pub. Date: May 6, 2021

(54) GRAIN-ORIENTED ELECTRICAL STEEL SHEET AND MANUFACTURING METHOD THEREFOR

(71) Applicant: POSCO, Pohang-si, Gyeongsangbuk-do (KR)

(72) Inventors: Kyu-Seok HAN, Pohang-si, Gyeongsangbuk-do (KR); Chang Soo PARK, Pohang-si, Gyeongsangbuk-do (KR); Jae-Kyoum KIM, Pohang-si, Gyeongsangbuk-do (KR); Jong-Tae PARK, Pohang-si, Gyeongsangbuk-do (KR)

(21) Appl. No.: 16/472,485

(22) PCT Filed: Dec. 20, 2017
(86) PCT No.: PCT/KR2017/015130

§ 371 Date: Jun. 21, 2019

(30) Foreign Application Priority Data
Dec. 22, 2016 (KR) 10-2016-0177047

(51) Int. Cl. C22C 38/06; C22C 38/00; C22C 38/02; C22C 38/04; C21D 8/02; C21D 9/00; C21D 9/46; C22C 38/14

(52) U.S. Cl. CPC C22C 38/06; C22C 38/008; C22C 38/02; C22C 38/002; C22C 38/004; C22C 38/04; C22C 38/14; C21D 8/0236; C21D 9/0081; C21D 9/46; C21D 8/0205; C21D 8/021; C21D 8/0226

(57) ABSTRACT

A grain-oriented electrical steel sheet according to an embodiment of the prevent invention comprises: Si: 1.0% to 7.0%, C: 0.005% or less (excluding 0%), P: 0.0010 to 0.1%, Sn: 0.005 to 0.2%, S: 0.0005 to 0.020%, Se: 0.0005 to 0.020% and B: 0.0001 to 0.01% by weight, and the remainder comprising Fe and other inevitable impurities.

### BACKGROUND OF THE INVENTION

### (a) Field of the Invention

The present invention relates to a grain-oriented electrical steel sheet and manufacturing method thereof. More particularly, the present invention relates to a grain-oriented electrical steel sheet using a composite grain boundary segregation of S and Se and a composite inclusion of Fe (S, Se), and manufacturing method thereof.

### (b) Description of the Related Art

The grain-oriented electrical steel sheet has excellent magnetic properties in the rolling direction by forming, on the entire steel sheet, a Goss aggregate structure ({110}<001> aggregate structure) which has a grain orientation of the steel sheet surface in the {110} plane and a crystal orientation in the rolling direction parallel to the <001> axis, and is a soft magnetic material used as an iron core of an electronic device requiring excellent one-directional magnetic characteristics, such as a large-sized rotary machines such as various transformers and generators.

The magnetic properties of an electrical steel sheet may be described by magnetic flux density and iron loss, and a high magnetic flux density may be obtained by precisely aligning the orientation of the grains in the {110}<001> orientation. The electrical steel sheet having a high magnetic flux density not only makes it possible to reduce the size of the iron core material of the electric device, but also reduces the hysteresis loss, thereby achieving miniaturization and high efficiency of the electric device at the same time.

Iron loss is a power loss consumed as heat energy when an arbitrary alternating magnetic field is applied to a steel sheet, and it largely changes depending on the magnetic flux density and the thickness of the steel sheet, the amount of impurities in the steel sheet, specific resistance and the size of the secondary recrystallization grain, wherein the higher the specific resistance and the lower the thickness and the amount of impurities in the steel sheet, the lower the iron loss and the higher the efficiency of the electric device.

A grain-oriented electrical steel sheet is produced through hot rolling, hot-rolled sheet annealing, cold rolling, recrystallization annealing, and high temperature annealing, and in order to develop a strong Goss structure throughout the steel sheet, an abnormal grain growth phenomenon called secondary recrystallization is used. This abnormal grain growth occurs when the movement of grain boundary in which grains normally grow is suppressed by precipitates, inclusions, or elements that are dissolved or segregated in the grain boundaries, unlike ordinary crystal grain growth. As described above, precipitates and inclusions that inhibit grain growth are specifically referred to as grain growth inhibitors, and studies on the production technology of grain-oriented electrical steel sheets by secondary recrystallization of Goss orientation have been focused on securing superior magnetic properties by using a strong grain growth inhibitor to form secondary recrystallization with high integration to Goss orientation.

MnS was used as a grain growth inhibitor in the grain-oriented electrical steel sheet which was initially developed and was manufactured by the method of cold rolling two times. As a result, the secondary recrystallization was formed stably, but the magnetic flux density was not so high and the iron loss was high. Thereafter, a method of manufacturing a grain-oriented electrical steel sheet by using a combination of AlN and MnS precipitates and then one-time cold rolling at a cold rolling rate of 80% or more has been proposed.

Recently, a grain-oriented electrical steel sheet manufacturing method in which secondary recrystallization is caused by an Al-based nitride exhibiting a strong grain growth inhibiting effect by supplying nitrogen into the steel sheet through a separate nitriding process using ammonia gas after decarburizing after one-time cold rolling without using MnS has been proposed.

Almost all steel manufacturers that manufacture grain-oriented electrical steel sheets so far have used a manufacturing method in which precipitates such as AlN and MnS [Se] are used as grain growth inhibitors to cause secondary recrystallization. Such a manufacturing method has an advantage of stably inducing secondary recrystallization, but in order to exhibit a strong grain growth inhibiting effect, the precipitates should be distributed very finely and uniformly on the steel sheet. In order to uniformly distribute the fine precipitates in this manner, the slab should be heated at a high temperature of 1300° C. or higher for a long period of time before hot rolling to dissolve coarse precipitates present in the steel, and then hot rolled in a very short time to complete the hot rolling without precipitation. This requires a large amount of slab heating equipment and in order to minimize precipitation, there are restrictions that the hot rolling and the winding process must be strictly controlled in order to suppress the precipitation as much as possible, and that the precipitates solidified in the hot-rolled sheet annealing step after hot-rolling should be controlled so as to be finely precipitated. In addition, when the slab is heated at a high temperature, the slab washing phenomenon occurs due to the formation of Fe₂SiO₄ having a low melting point, thereby decreasing the actual yields. In addition, the method of manufacturing a grain-oriented electrical steel sheet in which secondary recrystallization is caused by using AlN or MnS precipitates as a grain growth inhibitor has a cost burden and complication in the manufacturing process that the purification annealing should be performed for a long time at a high temperature of 1200° C. for at least 30 hours in order to remove precipitate components after completion of the secondary recrystallization. That is, since when a precipitate such as AlN or MnS is used as a grain growth inhibitor to form a secondary recrystallization and subsequently the precipitates remain in the steel sheet, the movement of the magnetic domain is disturbed, it should be removed, and to accomplish this, precipitate and other impurities such as AlN and MnS are removed by performing purification annealing for a long time by using 100% hydrogen gas at a high temperature of about 1200° C. after completion of the secondary recrystallization.

By this purification annealing, MnS precipitates are separated into Mn and S, Mn is dissolved in the steel, and S diffuses to the surface and reacts with hydrogen gas in the atmosphere, and is formed into H₂S and discharged. In the high temperature purification annealing process, the AlN-based precipitates are decomposed into Al and N, and Al moves to the surface of the steel sheet and reacts with oxygen in the surface oxidation layer to form Al₂O₃ oxide, wherein the Al-based oxide thus formed or the AlN precipitates which are not completely decomposed in the purification annealing process interfere with the movement of the magnetic domains in the steel sheet or near the surface, thereby deteriorating the iron loss. As described above, even if high-temperature annealing is performed at a high temperature for a long time in order to remove impurities, a certain amount of Al and Mn are added for the purpose of precipitate formation in the steelmaking step, so that the precipitates or oxides containing Al and Mn are inevitably retained in the final product at least and cause magnetic deterioration.

In the recently developed production technology of grain-oriented electrical steel sheet by a slab low temperature heating method in which secondary recrystallization is formed by AlN-based nitride precipitates through nitriding after decarburization annealing after cold rolling, since the Mn content is higher than that of the slab high a cost burden and complication in the manufacturing process that the purification annealing should be performed for a long time at a high temperature of 1200° C. for at least 30 hours in order to remove precipitate components after completion of the secondary recrystallization.

Therefore, in order to further improve the magnetic properties of the grain-oriented electrical steel sheet and to reduce the burden of the purification annealing to improve the productivity, a new technique for manufacturing a grain-oriented electrical steel sheet which does not use a precipitate such as AlN or MnS as a grain growth inhibitor is required.

As a method for manufacturing a grain-oriented electrical steel sheet without using an AlN or MnS precipitate as a grain growth inhibitor, there is a method of preferentially growing a {110}<001> orientation using surface energy as a crystal growth driving force. This method is based on the fact that the grains existing on the surface of the steel sheet have different surface energies depending on the crystal orientation and the grains of {110} plane having the lowest surface energy grow by encroaching other grains having higher surface energy, wherein in order to effectively use the difference in surface energy, there is a problem that the thickness of the steel sheet should be thin. However, the thickness of the grain-oriented electrical steel sheet widely used in the transformer manufacturing process currently is 0.20 mm or more, and there is a technical difficulty in forming the secondary recrystallization using the surface energy at a product thickness of more than 0.20 mm. In addition, there is a problem in that the process using the surface energy greatly affects the process load in the cold rolling process when it is manufactured to a thickness of 0.20 mm or less. In addition, since in order to effectively use the surface energy, secondary recrystallization should be performed in a state in which oxide formation on the surface of the steel sheet is suppressed actively, therefore, it is absolutely required to make a high temperature annealing atmosphere a vacuum or a mixed gas atmosphere of inert gas and hydrogen gas. In addition, since an oxide layer is not formed on the surface, it is impossible to form Mg₂SiO₄ (forsterite) coating in a high-temperature annealing process in which final secondary recrystallization is formed, such that there is a disadvantage that insulation is difficult and iron loss is increased.

On the other hand, a method for manufacturing a grain-oriented electrical steel sheet is proposed in which secondary recrystallization is formed by minimizing the impurity content in the steel sheet without using precipitates and maximizing a difference in grain boundary mobility depending on the crystal orientation. In this technique, it has been proposed to suppress the content of Al to 100 ppm or less and the content of B, V, Nb, Se, S, P and N to 50 ppm or less, but, in the actual embodiment shown, it is shown that a small amount of Al should form precipitates or inclusions to stabilize the secondary recrystallization. Therefore, it may not be regarded as a method for manufacturing a grain-oriented electrical steel sheet substantially free of precipitates, and the magnetic properties obtained thereby are also lower than the magnetic properties of the current commercial grain-oriented electrical steel sheet products. Further, even if all the impurities in the steel sheet are removed as much as possible to secure low iron loss characteristics, the problem of increasing the cost burden in terms of productivity cannot be solved.

In addition, attempts have been made to use various precipitates such as TiN, VN, NbN, and BN as a grain growth inhibitor, but, due to thermal instability and excessively high precipitate decomposition temperature, formation of stable secondary recrystallization has failed.

### CONTENTS OF THE INVENTION

### Problem to Solve

In one embodiment of the present invention, a grain-oriented electrical steel sheet and a method of manufacturing the same are provided. More specifically, a grain-oriented electrical steel sheet using composite grain boundary segregations of S and Se and composite inclusions of Fe (S, Se) as a grain growth inhibitor and manufacturing method thereof.

### SUMMARY OF THE INVENTION

The grain-oriented electrical steel sheet according to an embodiment of the present invention comprises: Si: 1.0% to 7.0%, C: 0.005% or less (excluding 0%), P: 0.0010 to 0.1%, Sn: 0.005 to 0.2%, S: 0.0005 to 0.020%, Se: 0.0005 to 0.020% and B: 0.0001 to 0.01% by weight, and the remainder comprising Fe and other inevitable impurities.

The grain-oriented electrical steel sheet according to an embodiment of the present invention may comprise 0.005 to 0.04 wt % of S and Se in a total amount.

The grain-oriented electrical steel sheet according to an embodiment of the present invention may further comprise Al: 0.010 wt % or less, Mn: 0.08 wt % or less and N: 0.005 wt % or less.

The grain-oriented electrical steel sheet according to an embodiment of the present invention may comprise composite grain boundary segregation of S and Se, and composite inclusion of Fe (S, Se). The grain-oriented electrical steel sheet according to an embodiment of the present invention may comprise 0.01 to 500 pieces/mm² of element inclusions comprising Al, Mn, Si, Mg, Ca, B or Ti.

The grain-oriented electrical steel sheet according to an embodiment of the present invention may further comprise 0.005 wt % or less of at least one of Ti, Mg and Ca, respectively.

A method for manufacturing a grain-oriented electrical steel sheet according to an embodiment of the present invention comprises: heating a slab comprising Si: 1.0 to 7.0%, C: 0.001 to 0.10%, P: 0.0010 to 0.1%, Sn: 0.005 to 0.2%, S: 0.0005 to 0.020%, Se: 0.0005 to 0.020%, and B: 0.0001 to 0.01% by weight, and the remainder comprising Fe and other inevitable impurities; hot-rolling the slab to produce a hot-rolled sheet; cold-rolling the hot-rolled sheet to produce a cold-rolled sheet; primary recrystallization annealing the cold-rolled sheet; and secondary recrystallization annealing the cold-rolled sheet which is the primary recrystallization annealed.

The slab may comprise 0.005 to 0.04 wt % of S and Se in a total amount.

The slab may further comprise Al: 0.010 wt % or less, Mn: 0.08 wt % or less and N: 0.005 wt % or less.

The slab may further comprise 0.005 wt % or less of at least one of Ti, Mg and Ca, respectively.

A side edge crack of the hot-rolled sheet may occur 20 mm or less after the step of producing the hot-rolled sheet.

The method may further comprise a step of annealing the hot-rolled sheet after the step of producing the hot-rolled sheet.

The step of cold-rolling the hot-rolled sheet to produce a cold-rolled sheet may comprise a step of cold-rolling at least two times, and a step of intermediate annealing between cold-rolling.

The step of secondary recrystallization annealing may comprise a step of temperature-raising and a step of soaking, wherein the step of temperature-raising may be performed in mixed atmosphere of nitrogen and hydrogen, and the step of soaking is performed in hydrogen atmosphere.

The step of soaking may be performed at a temperature of 1000 to 1250° C. for 20 hours or less.

### Effect of the Invention

The grain-oriented electrical steel sheet according to an embodiment of the present invention is excellent in magnetic properties by stably forming Goss grains.

In addition, Al and Mn-containing precipitates which are detrimental to magnetic properties are minimized, and magnetic properties are excellent.

Further, it is possible to minimize the side edge crack of the hot-rolled sheet in the manufacturing process, and the productivity is excellent.

In addition, the step of soaking in the secondary recrystallization annealing can be carried out at a low temperature for a short time in the manufacturing process, and the productivity is excellent.

### BRIEF DESCRIPTION OF THE DRAWINGS

FIG. 1 shows the result of observation of the inclusion of the invention material 16.

FIG. 2 shows the results of analysis of the inclusion component of the invention material 16.

### DETAILED DESCRIPTION OF THE EMBODIMENTS

The first term, second and third term, etc. are used to describe various parts, components, regions, layers and/or sections, but are not limited thereto. These terms are only used to distinguish any part, component, region, layer or section from other part, component, region, layer or section. Therefore, the first part, component, region, layer or section may be referred to as the second part, component, region, layer or section within the scope unless excluded from the scope of the present invention.

The terminology used herein is only to refer specific embodiments and is not intended to be limiting of the invention. The singular forms used herein comprise plural forms as well unless the phrases clearly indicate the opposite meaning. The meaning of the term “comprise” is to specify a particular feature, region, integer, step, operation, element and/or component, not to exclude presence or addition of other features, regions, integers, steps, operations, elements and/or components.

It will be understood that when an element such as a layer, coating, region, or substrate is referred to as being “on” another element, it can be directly on the other element or intervening elements may also be present. In contrast, when an element is referred to as being “directly on” another element, there are no intervening elements present.

Although not defined differently, every term comprising technical and scientific terms used herein have the same meaning as commonly understood by those who is having ordinary knowledge of the technical field to which the present invention belongs. The commonly used predefined terms are further interpreted as having meanings consistent with the relevant technology literature and the present content and are not interpreted as ideal or very formal meanings unless otherwise defined.

In addition, unless otherwise stated, % means wt %, and 1 ppm is 0.0001 wt %.

In an embodiment of the present invention, the meaning further comprising additional elements means that the remainder (Fe) is replaced by additional amounts of the additional elements.

Hereinafter, embodiments of the present invention will be described in detail so that those skilled in the art may easily carry out the present invention. The present invention may, however, be implemented in several different forms and is not limited to the embodiments described herein.

In the conventional grain-oriented electrical steel sheet technology, precipitates such as AlN and MnS are used as grain growth inhibitors. The process conditions were extremely constrained due to the conditions for all the processes to strictly control the distribution of precipitates and to remove the precipitate remaining in the secondary recrystallized steel sheet.

On the other hand, in one embodiment of the present invention, precipitates such as AlN and MnS are not used as the crystal growth inhibitor. A composite grain boundary segregation of S and Se and Fe (S, Se) composite inclusions are used as grain growth inhibitors, so that it is possible to increase the fraction of Goss grain and obtain an electrical steel sheet excellent in magnetic properties. Further, the addition of B minimizes the occurrence of the side edge crack of the hot-rolled sheet due to addition of S and Se.

In one embodiment of the present invention, by adding Se having chemical characteristics similar to S with S, it is possible to obtain a more effective grain growth inhibiting ability than in the case of adding S alone, to secure excellent magnetic properties by stable secondary recrystallization, and to reduce the amount of edge cracks generated when S is added alone. Since Se has a larger atomic size and mass than S, it has a large effect of retarding the grain boundary migration during grain boundary segregation, wherein the effect is considered to be greater when being segregated in combination with S in the grain boundary. Compare to the phenomenon in which the suppressive force is weakened by the phase transformation of FeS precipitates into a liquid phase at 1000° C. or higher, in the Fe (S, Se) composite precipitate, since the phase transformation at 1000° C. or higher is delayed and the grain growth restraining force is stably maintained even at such a high temperature, it is considered that Fe (S, Se) composite precipitates are more resistant to grain growth than FeS precipitates.

In addition, it was confirmed that edge crack was significantly reduced during the hot rolling process after continuous casting and slab heating with the complex addition of S and Se. The reason for this is considered as that since the segregation effect of Se is as strong as that of S, but the melting point or boiling point is higher than S, it could exist relatively stable at high temperature when grain boundary segregation. In addition to the complex addition of S and Se, the addition of B in the steelmaking step significantly reduced the occurrence of the side edge crack during continuous casting and hot rolling due to the effect of strengthening coherence of grain boundary of B. Since B has an effect of strengthening a grain boundary and also has an effect of suppressing the movement of grain boundaries by forming precipitates such as BN, by inducing the reaction with nitrogen gas in the atmospheric gas during the annealing process, it could be used as a grain growth inhibitor together with S and Se.

A grain-oriented electrical steel sheet according to an embodiment of the present invention comprises: 1 Si: 1.0% to 7.0%, C: 0.005% or less (excluding 0%), P: 0.0010 to 0.1%, Sn: 0.005 to 0.2%, S: 0.0005 to 0.020%, Se: 0.0005 to 0.020% and B: 0.0001 to 0.01% by weight, and the remainder comprising Fe and other inevitable impurities.

Hereinafter, each component will be described in detail.

Si: 1.0 to 7.0 wt %

Silicon (Si) is a basic composition of an electrical steel sheet, which increases the resistivity of the steel sheet and serves to lower core loss, that is, iron loss, of the transformer. When the content of Si is too small, the specific resistance of the steel decreases to deteriorate the property of iron loss, and a phase transformation section during high temperature annealing is presented so that the secondary recrystallization may become unstable. When the content of Si is too large, brittleness of steel is increased, thus cold rolling becomes extremely difficult, the content of C for containing an austenite fraction of 40% or more is greatly increased, and secondary recrystallization becomes unstable. Therefore, 1.0 to 7.0 wt % of Si may be comprised. More particularly, 2.0 to 4.5 wt % of Si may be comprised.

C: 0.005 wt % or Less

Carbon (C) is an austenite stabilizing element, and it causes a phase transformation at a temperature of 900° C. or higher, thereby refining the coarse columnar structure occurring in the continuous casting process, and suppressing the slab center segregation of S. It also promotes work hardening of the steel sheet during cold rolling, thereby promoting the generation of secondary recrystallization nuclei in {110}<001> orientation in the steel sheet. Therefore, although there is no great restriction on the amount of addition, when it is contained in the slab in an amount of less than 0.001 wt %, a phase transformation and work hardening effect cannot be obtained, and when it is added in an amount exceeding 0.1 wt %, edge crack may occur, so that a problem in work may occur and a decarburization process may be burdened when decarburization annealing is performed after cold rolling. Therefore, the amount of addition in the slab may be 0.001 to 0.1 wt %.

In one embodiment of the present invention, the decarburization annealing is performed in the primary recrystallization annealing step in the manufacturing process, and the C content in the final electrical steel sheet produced after decarburization annealing may be 0.005 wt % or less. More specifically, it may be 0.003 wt % or less.

P: 0.0010 to 0.1 wt % Phosphorus (P) has an effect of inhibiting grain growth by segregating in a grain boundary and promotes recrystallization of {111}<112> orientation grains during primary recrystallization annealing to form a microstructure favorable for secondary recrystallization formation of Goss orientation grains. For this reason, it is preferable to add up to 0.1 wt %, and when it is added in an amount exceeding 0.1 wt %, the occurrence of sheet breakage during cold rolling increases so that the actual yields of the cold rolling rate are decreased. In addition, when the content is less than 0.0010 wt %, the addition effect may not be observed. Therefore, the control range of P in the slab and the final grain-oriented electrical steel sheet is limited to 0.0010 to 0.1 wt %.

Sn: 0.005 to 0.2 wt %

Tin (Sn), together with P, is a representative grain boundary segregation element and has the effect of increasing the magnetic flux density by promoting nucleation of the {110}<001> Goss orientation in the hot rolling process. Addition of up to 0.2 wt % of Sn has the effect of increasing the Goss orientation grains, but, when it is added in excess, the grain boundary segregation occurs severely, which will generate sheet breakage, and the decarburization is delayed, which will form non-uniform primary recrystallized microstructure, thereby the magnetic properties may be deteriorated. In addition, when it is added less than 0.005 wt %, the effect of forming the Goss orientation recrystallized grains is also weak, and the content of Sn in the slab and the final grain-oriented electrical steel sheet is limited to 0.005 to 0.2 wt %.

S: 0.0005 to 0.020 wt %

Sulfur (S) is an element having an effect of inhibiting a grain growth by reacting with Mn in the steel to form MnS, but in one embodiment of the present invention, since MnS is not used as a grain growth inhibitor, the Mn content is controlled to be minimum, thereby MnS formation is suppressed. On the other hand, S is an important element for causing secondary recrystallization by being segregated in the grain boundaries with Se or forming Fe (S, Se) composite precipitate. In one embodiment of the present invention, by adding S in combination with Se, grain growth inhibition may be more effectively used than in case of adding alone, so that S content is limited to the level of addition equivalent to Se. That is, 0.0005 to 0.020 wt % of S may be added. When the addition of S is too small, the effect of addition decreases, when the addition of S is excess, on the contrary, the occurrence of edge cracks in the continuous casting and hot rolling steps increases and the actual yields decrease, thus the S content in the slab and the final grain-oriented electrical steel sheet is limited to 0.0005 to 0.020 wt %.

Se: 0.0005 to 0.020 wt %

Selenium (Se) is treated as a core element in one embodiment of the present invention. Se is segregated in combination with S to in the grain boundaries, and at the same time, Fe (S, Se) composite precipitates are formed in the grain boundaries to strongly inhibit grain boundary movement, thereby promoting the formation of secondary recrystallization of {110}<001> Goss orientation grains. In the case of adding Se alone, as in the case of adding S alone, it is possible to secure the stable magnetic property only when the amount of single addition for causing the secondary recrystallization is greater than that of composite addition. However, in the case of such a single addition, it is possible to ensure magnetic properties, but the occurrence of edge cracks in the slab continuous casting and hot rolling process is increased, resulting in a problem of lowering the overall actual yields.

As in one embodiment of the present invention, when the grain boundary segregation and the Fe (S, Se) precipitate are formed by adding S and Se in a composite manner, the magnetic properties and actual yields were improved as compared with the case where the single element was added. Based on these results, it is effective to add the Se content in the steelmaking step to the same level, and the upper limit is preferably not more than 0.02 wt %. In the composition of the present invention which is added in combination with S, if it exceeds 0.02 wt %, excessive formation grain boundary segregation and Fe (S, Se) precipitates increases edge cracks during the continuous casting and hot rolling. On the other hand, if it is added less than 0.0005 wt %, segregation of Se and formation of Fe (S, Se) precipitates are reduced and the effect of suppressing grain growth is deteriorated. Therefore, the addition amount of Se in the slab and the final grain-oriented electrical steel sheet is limited to 0.0005 to 0.020 wt %.

The above-mentioned S and Se may be controlled as in a total amount. In the slab and the final grain-oriented electrical steel sheet, S and Se may be comprised 0.005 to 0.04 wt % in a total amount. When the total amount is too small, the formation of the composite segregation of S and Se and the Fe (S, Se) precipitates is reduced, and the effect of suppressing grain growth is deteriorated. When the total amount is too large, the occurrence of edge cracks may increase during the continuous casting and hot rolling process.

B: 0.0001 to 0.01 wt %

Boron (B) reacts with N in the steel to form BN precipitates to inhibit grain growth, but it is an element effective to reduce the occurrence of edge cracks during hot rolling by suppressing grain boundary propagation of defects and cracks by strengthening the bonding coherence of grain boundaries by segregating into grain boundaries. As in one embodiment of the present invention, in order to minimize the possibility of the occurrence of edge cracks in the case of adding S and Se in combination, it is preferable to add B at a content of up to 0.01 wt %. When the content of B is excessively high, there may be a problem of increasing the high temperature brittleness due to the formation of intermetallic compounds. On the contrary, when the amount is too small, the occurrence of edge cracks due to the addition of B may not be suppressed, and thus the content of B in the slab and the final grain-oriented electrical steel sheet is limited to 0.0001 to 0.01 wt %.

Al: 0.010 wt % or Less

Aluminum (Al) bonds with nitrogen in the steel to form AN precipitates, and thus, in one embodiment of the present invention, formation of inclusions such as Al-based nitride and oxide is avoided by aggressively suppressing the content of Al. If the content of the acid soluble Al is too much, the formation of AlN and Al₂O₃ is promoted, and the purification annealing time for removing the AlN and Al2O3 is increased, and the AlN precipitates and the inclusions such as Al2O3 that have not been removed remain in the final product to increase the coercive force, thereby the iron loss may increase, so that the content of Al in the steelmaking step is aggressively suppressed to 0.010 wt % or less. More specifically, the content of Al may be controlled to 0.001 to 0.010 wt % in consideration of the load of the steelmaking process.

Mn: 0.08 wt % or Less

Like Si, manganese (Mn) has the effect of reducing the iron loss by increasing the specific resistance, but the main purpose of the addition in the prior art is to react with S in the steel to form MnS precipitates to inhibit grain growth. However, in one embodiment of the present invention, since the Fe (S, Se) composite precipitate is used without using the MnS precipitate as a crystal grain growth inhibitor, the Mn content needs to be limited within a content range in which MnS is not formed.

The most ideal method is that no Mn is added, but the Mn content remains in a certain amount even if a molten iron having a low Mn content is used in a ironmaking and a steel making process, and if the Mn content is inevitably remained, the content thereof is preferably limited to 0.08 wt %. When Mn is added in a large amount, MnS [Se] is precipitated, so that the grain boundary segregation of S and Se become small, and thus it is difficult to inhibit the movement of grain growth, and formation of Fe (S, Se) composite precipitates becomes difficult. Furthermore, the MnS [Se] precipitates have a high dissolution temperature and exist as precipitates having a very large size on the actual steel sheet, and the growth inhibiting ability is also lowered. In addition, there is a disadvantage in that it is necessary to anneal at a high temperature for a long time in order to decompose MnS [Se] in a high temperature annealing purification process. For this reason, in one embodiment of the present invention, the maximum content of Mn is controlled to 0.08 wt % or less. It is best not to add Mn, but to lower it to less than 0.001 wt %, the steelmaking process load increases and thus the productivity drops, so the lower limit of Mn may be limited to 0.001 wt %.

N: 0.005 wt % or Less

N is an element that reacts with Al and Si to form AlN and Si₃N₄ precipitates. It also reacts with B to form BN. In the present invention, since AlN is not used as a grain growth inhibitor, an acid-soluble Al is not added in the steelmaking step, so N is not particularly arbitrarily added. Further, in the present invention, formation of BN is not preferable since B is added to increase grain boundary coherence. For this reason, the upper limit of N is limited to a maximum of 0.005 wt %, securing the effect of enhancing the grain boundary coherence of B itself due to BN precipitation. In addition, it is preferable that N is not added or added at a minimum, but, since the denitrification load in the steelmaking process is greatly increased when N is controlled to be less than 0.0005 wt % in the steelmaking step, N is limited to 0.0005 to 0.005 wt % in the steelmaking step. In one embodiment of the present invention, since the nitriding process may be omitted, the content of N in the slab and the content of N in the final grain-oriented electrical steel sheet may be substantially the same.

Other Elements

Components such as titanium (Ti), magnesium (Mg) and calcium (Ca) react with oxygen or nitrogen in the steel to form oxides or nitrides, and thus it is necessary to strongly suppress so that it may be controlled to 0.005 wt % or less for each component. More specifically, it may be controlled to 0.003 wt % or less for each component.

A composite grain boundary segregation of S and Se and F (S, Se) composite inclusions are comprised by addition of specific contents of S and Se. In one embodiment of the present invention, an Fe (S, Se) composite inclusion means an Fe—S, Fe—Se or Fe—S—Se intermetallic compound formed by reacting with Fe.

In one embodiment of the present invention, as described above, the content of Al, Mn, N and the like is aggressively suppressed, so that the number of inclusions formed on the grain-oriented electrical steel sheet may be controlled to be small. These inclusions cause deterioration of the magnetic properties of the grain-oriented electrical steel sheet, and in one embodiment of the present invention, their generation is fundamentally blocked, so that the magnetic properties are excellent. Further, there is no need to perform a long time annealing at a high temperature for removing inclusions in the manufacturing process, and the productivity is excellent. In an embodiment of the present invention, an inclusion means an inclusion comprising Al, Mn, Si, Mg, Ca, B or Ti. More specifically, the inclusion means an oxide, a sulfide, a nitride or a carbide of Al, Mn, Si, Mg, Ca, B or Ti. In one embodiment of the present invention, the number of inclusions means the number of inclusions observed per unit area when observing the grain-oriented electrical steel sheet on a plane perpendicular to the thickness direction of the grain-oriented electrical steel sheet.

In an embodiment of the present invention, not only the number of inclusions is reduced but also the average particle diameter of the inclusions to be formed is small. In one embodiment of the present invention, the average particle diameter of the inclusions may be 0.01 to 1.0 μm. In this case, the particle diameter of the inclusion means an average of the particle diameters of the imaginary circle circumscribing the inclusion and the imaginary circle inscribing the inclusion.

As described above, in one embodiment of the present invention, a composite grain boundary segregation of S and Se and a Fe (S, Se) composite inclusion are used as grain growth inhibitors to produce a grain-oriented electrical steel sheet having excellent magnetic properties. Specifically, in an embodiment of the present invention, the magnetic flux density Bs may be 1.90 T or more and the iron loss W_{17/50} may be 1.00 W/kg or less. In this case, the magnetic flux density Bs is a magnitude of the magnetic flux density (Tesla) induced under a magnetic field of 800 A/m and the iron loss W_{17/50} is the magnitude of iron loss (W/kg) induced at 1.7 Tesla and 50 Hz.

A method of manufacturing a grain-oriented electrical steel sheet according to an embodiment of the present invention comprises heating a slab comprising Si: 1.0 to 7.0%, C: 0.001 to 0.10%, P: 0.0010 to 0.1%, Sn: 0.005 to 0.2%, S: 0.0005 to 0.020%, Se: 0.0005 to 0.020%, and B: 0.0001 to 0.01% by weight, and the remainder comprising Fe and other inevitable impurities; hot-rolling the slab to produce a hot-rolled sheet; cold-rolling the hot-rolled sheet to produce a cold-rolled sheet; primary recrystallization annealing the cold-rolled sheet; and secondary recrystallization annealing the cold-rolled sheet which is the primary recrystallization annealed.

Hereinafter, a manufacturing method of the grain-oriented electrical steel sheet will be described in detail for each step.

First, the slab is heated. In the steelmaking stage, the main elements such as Si, C, P, Sn, S, Se, and B are controlled in an appropriate amount, and alloying elements favorable for formation of Goss aggregate structure may be added if necessary. The molten steel whose composition is adjusted in the steelmaking process is made into a slab through continuous casting. A strip casting method may be used in which hot rolled steel sheet is produced by injecting molten steel into a twin roll.

Since the composition of the slab has been described in detail with respect to the composition of the electrical steel sheet, a duplicate description will be omitted.

The heating temperature of the slab is not limited, but, if the slab is heated to a temperature of 1300° C. or less, it is possible to prevent the columnar structure of the slab from being grown to be coarse, thereby preventing occurring cracks of the sheet in the hot rolling process. Thus, the heating temperature of the slab may be between 1050° C. and 1300° C. In particular, in one embodiment of the present invention, since AlN and MnS are not used as a grain growth inhibitor, it is not necessary to heat the slab at a high temperature exceeding 1300° C.

Then, the slab is hot-rolled to produce a hot-rolled sheet. The hot rolling temperature is not limited, and in one embodiment hot rolling may be terminated at 950° C. or less. Thereafter, it is water-cooled and may be wound at 600° C. or less. A hot rolled sheet having a thickness of 1.5 to 4.0 mm may be produced by hot rolling. At this time, in one embodiment of the present invention, side edge cracks are reduced by adding S and Se in combination and further adding B. A side edge crack means a crack generated in the width direction of the steel sheet from the end of the steel sheet toward the inside of the steel sheet. In one embodiment of the present invention, the length of a side edge crack of the hot-rolled sheet may be 20 mm or less. When the length of the side edge crack is long, the amount of cutting is increased correspondingly, and the actual yields is greatly reduced. In one embodiment of the present invention, the side edge cracks of the hot-rolled sheet are reduced as much as possible, thereby preventing the decrease of actual yields and improving the productivity.

Then, the hot-rolled sheet may be subjected to hot-rolled sheet annealing if necessary. In the case of performing hot-rolled sheet annealing, it may be heated to a temperature of 900° C. or more, cooled and then soaked to make the hot-rolled structure uniform.

Then, the hot-rolled sheet is cold-rolled to produce a cold-rolled sheet. Cold rolling is carried out by using a cold rolling method using a Reverse rolling mill or a Tandom rolling mill by several times of cold rolling methods including one-time cold rolling, several times of cold rolling, or an intermediate annealing to produce a cold-rolled sheet having a thickness of 0.1 mm to 0.5 mm.

Further, warm rolling in which the temperature of the steel sheet is maintained at 100° C. or higher during cold rolling may be performed.

In addition, the final rolling reduction through cold rolling may be from 50 to 95%.

Next, the cold-rolled sheet after cold-rolling is subjected to primary recrystallization annealing. Primary recrystallization occurs in which the nuclei of the Goss grain is generated in the primary recrystallization annealing step. The decarburization of the cold-rolled sheet may be performed in the primary recrystallization annealing step. Annealing may be performed at a temperature of 800° C. to 950° C. and a dew point temperature of 50° C. to 70° C. for decarburization. When heated above 950° C., the recrystallized grains grow to to be coarse and the grain growth driving force drops, so that a stable secondary recrystallization is not formed. The annealing time is not a serious problem in exerting the effect of the present invention, but it is preferable to treat it within 5 minutes in consideration of productivity.

Further, the atmosphere may be a mixed gas atmosphere of hydrogen and nitrogen. Further, when the decarburization is completed, the content of carbon in the cold rolled steel sheet may be 0.005 wt % or less. More specifically, the content of carbon may be 0.003 wt % or less. Further, at the same time as decarburization, an appropriate amount of oxide layer is formed on the surface of the steel sheet. The grain diameter of the recrystallized grains grown in the primary recrystallization annealing process may be 5 μm or more. In one embodiment of the present invention, since the AlN grain growth inhibitor is not used, the nitriding step may be omitted.

Then, the cold-rolled sheet, in which the primary recrystallization annealing is completed, is subjected to secondary recrystallization annealing. At this time, after the annealing separator is applied to the cold-rolled sheet in which the primary recrystallization annealing is completed, secondary recrystallization annealing may be performed. At this time, the annealing separator is not particularly limited, and an annealing separator containing MgO as a main component may be used.

The step of secondary recrystallization annealing includes a temperature-raising step and a soaking step. The step of temperature-raising is a step of raising the temperature of the cold-rolled sheet after primary recrystallization annealing to the temperature of the soaking step, causing secondary recrystallization in the {110}<001> Goss orientation.

The step of soaking is a step of removing impurities present in the steel sheet, and the temperature of the step of soaking is 900° C. to 1250° C. and may be carried out for 20 hours or less. If the temperature is less than 900° C., the Goss grains may not sufficiently grow and the magnetic properties may deteriorate, and when the temperature exceeds 1250° C., the grains may grow to be coarse so that the characteristics of the electrical steel sheet may deteriorate. The step of temperature-raising may be performed in a mixed gas atmosphere of hydrogen and nitrogen, and the step of soaking may be performed in hydrogen atmosphere. In one embodiment of the present invention, since the grain growth inhibitor such as AlN or MnS is not used, there is no need to anneal at a high temperature for a long time in order to remove the grain growth inhibitor, thereby improving the productivity.

Thereafter, an insulation film may be formed on the surface of the grain-oriented electrical steel sheet or a treatment of refining the magnetic domain may be carried out, if necessary. In one embodiment of the present invention, the alloy component of the grain-oriented electrical steel sheet refers to a substrate steel sheet excluding a coating layer such as an insulation coating.

Hereinafter, the present invention will be described in more detail with reference to examples. However, these examples are only for illustrating the present invention, and the present invention is not limited thereto.

### Example 1

A slab containing C: 0.055%, Si: 3.2%, P: 0.03%, Sn: 0.04%, B: 0.005%, N: 0.002% by weight and M, S and Se with varying contents as shown in Table 1 below, with the remainder containing Fe and other inevitable impurities was prepared.

The slab was heated to a temperature of 1250° C. and hot-rolled to a thickness of 2.3 mm. After measuring the occurrence depth of the side edge crack of the hot-rolled sheet, the hot-rolled sheet after hot-rolling was heated to a temperature of 950° C. and then soaked for 120 seconds to perform hot-rolled sheet annealing.

Subsequently, the annealed hot-rolled steel sheet was pickled and then cold-rolled to produce a cold-rolled sheet having a thickness of 0.30 mm. The cold-rolled steel sheet was subjected to decarburization and recrystallization heat treatment by maintaining it at a temperature of 830° C. for 180 seconds in a wet, mixed gas atmosphere of hydrogen and nitrogen having a dew point temperature of 60° C.

The steel sheet was applied with MgO, which is an annealing separator, and subjected to final secondary recrystallization annealing in a type of a coil. The secondary recrystallization annealing was carried out in a mixed atmosphere of 25 vol % of nitrogen and 75 vol % of hydrogen until 1050° C., and after reaching 1050° C., the secondary recrystallization annealing was maintained in a 100 vol % of hydrogen gas atmosphere for 20 hours and then furnace cooled. The magnetic flux density (B₈, 800 A/m) and iron loss (W_{17/50}) of steel sheet after secondary recrystallization annealing were measured by single sheet measurement method. Table 1 shows the measurement results and the amount of side edge cracks generated in the hot-rolled sheet according to the changes in Mn, S, and Se contents.

TABLE 1

| | | | | Side edge | Magnetic flux | Iron loss | |
|---|---|---|---|---|---|---|---|
| Mn | S | Se | S + Se | crack | density | (W_{17/50}, | |
| (wt %) | (wt %) | (wt %) | (wt %) | (mm) | (B₈, Tesla) | W/kg) | Classification |
| 0.0021 | 0.0003 | 0.0003 | 0.0006 | 2 | 1.755 | 1.35 | Comparative |
| | | | | | | | material 1 |
| 0.0015 | 0.0030 | 0.0003 | 0.0033 | 2 | 1.891 | 1.07 | Comparative |
| | | | | | | | material 2 |
| 0.0018 | 0.0051 | 0.0005 | 0.0056 | 3 | 1.908 | 0.99 | Invention |
| | | | | | | | material 1 |
| 0.0034 | 0.0058 | 0.0053 | 0.0111 | 3 | 1.912 | 0.98 | Invention |
| | | | | | | | material 2 |
| 0.0125 | 0.0052 | 0.0094 | 0.0146 | 5 | 1.945 | 0.91 | Invention |
| | | | | | | | material 3 |
| 0.0259 | 0.0091 | 0.0128 | 0.0219 | 5 | 1.933 | 0.92 | Invention |
| | | | | | | | material 4 |
| 0.0316 | 0.0135 | 0.0075 | 0.0210 | 6 | 1.934 | 0.93 | Invention |
| | | | | | | | material 5 |
| 0.0390 | 0.0127 | 0.0182 | 0.0309 | 7 | 1.919 | 0.96 | Invention |
| | | | | | | | material 6 |
| 0.0458 | 0.0164 | 0.0163 | 0.0327 | 9 | 1.924 | 0.96 | Invention |
| | | | | | | | material 7 |
| 0.0504 | 0.0175 | 0.0189 | 0.0364 | 12 | 1.928 | 0.97 | Invention |
| | | | | | | | material 8 |
| 0.0721 | 0.0191 | 0.0195 | 0.0386 | 15 | 1.912 | 0.98 | Invention |
| | | | | | | | material 9 |
| 0.0789 | 0.0195 | 0.0198 | 0.0393 | 18 | 1.905 | 0.99 | Invention |
| | | | | | | | material 10 |
| 0.0828 | 0.0190 | 0.0195 | 0.0385 | 17 | 1.715 | 1.61 | Comparative |
| | | | | | | | material 3 |
| 0.0351 | 0.0225 | 0.0151 | 0.0376 | 18 | 1.889 | 1.09 | Comparative |
| | | | | | | | material 4 |
| 0.0292 | 0.0178 | 0.0215 | 0.0393 | 19 | 1.894 | 1.05 | Comparative |
| | | | | | | | material 5 |
| 0.0441 | 0.0191 | 0.0235 | 0.0426 | 21 | 1.853 | 1.17 | Comparative |
| | | | | | | | material 6 |

As shown in Table 1, when S and Se were added in combination and controlled in the range of the present invention, the magnetic flux density and iron loss were both excellent. In addition, edge cracks of the hot-rolled sheets were shown to be less than 20 mm. However, in the case of Comparative material 6 in which the total content of S and Se exceeds 0.04 wt %, an edge crack occurred more than 20 mm, and the magnetic properties also tended to be inferior. In the case of Comparative material 3 in which the content of Mn is more than 0.08 wt %, grain growth inhibiting effect is reduced due to precipitation of coarse MnS [Se] rather than Fe (S, Se) precipitation and stable secondary recrystallization does not occur, thereby the magnetic property is judged to be inferior.

### Example 2

A slab containing C: 0.06%, Si: 3.0%, Mn: 0.035%, S: 0.015%, Se: 0.015%, P: 0.02%, Sn: 0.06%, N: 0.0015% by weight and B with varying contents as shown in Table 2 below, with the remainder containing Fe and other inevitable impurities was prepared.

The slab was heated to a temperature of 1200° C. and hot-rolled to a thickness of 2.0 mm. After measuring the occurrence depth of the side edge crack of the hot-rolled sheet, the hot-rolled sheet after hot-rolling was heated to a temperature of 1000° C. and then soaked for 120 seconds to perform hot-rolled sheet annealing.

Subsequently, the annealed hot-rolled steel sheet was pickled and then cold-rolled to produce a cold-rolled sheet having a thickness of 0.23 mm. The cold-rolled steel sheet was subjected to decarburization and recrystallization heat treatment by maintaining it at a temperature of 820° C. for 150 seconds in a wet, mixed gas atmosphere of hydrogen and nitrogen having a dew point temperature of 60° C.

The steel sheet was applied with MgO, which is an annealing separator, and subjected to final secondary recrystallization annealing in a type of a coil. The secondary recrystallization annealing was carried out in a mixed atmosphere of 25 vol % of nitrogen and 75 vol % of hydrogen until 1150° C., and after reaching 1150° C., the secondary recrystallization annealing was maintained in a 100 vol % of hydrogen gas atmosphere for 15 hours and then furnace cooled. The magnetic flux density (B₈, 800 A/m) and iron loss (W_{17/50}) of steel sheet after secondary recrystallization annealing were measured by single sheet measurement method. Table 1 shows the measurement results and the amount of side edge cracks generated in the hot-rolled sheet according to the changes in B content.

TABLE 2

| | Side edge crack | Magnetic flux | Iron loss | |
|---|---|---|---|---|
| B | of hot-rolled | density | (W_{17/50}, | |
| (wt %) | sheet (mm) | (B₈, Tesla) | W/kg) | Classification |
| Not | 34 | 1.903 | 0.87 | Comparative |
| added | | | | material 7 |
| 0.0005 | 20 | 1.917 | 0.85 | Invention |
| | | | | material 11 |
| 0.0015 | 18 | 1.918 | 0.85 | Invention |
| | | | | material 12 |
| 0.0034 | 15 | 1.926 | 0.82 | Invention |
| | | | | material 13 |
| 0.0059 | 9 | 1.931 | 0.81 | Invention |
| | | | | material 14 |
| 0.0097 | 5 | 1.909 | 0.86 | Invention |
| | | | | material 15 |
| 0.0114 | 4 | 1.873 | 0.98 | Comparative |
| | | | | material 8 |

As shown in Table 2, in the case of Comparative material 7 to which B was not added exhibited excellent magnetic properties comparatively stably, but the edge crack of the hot-rolled sheet edge 34 mm, which results in an increase the amount of cutting of both edges of the hot-rolled sheet due to the edge cracks, resulting in decreased productivity.

On the other hand, in the case of Comparative material 8 in which the content of B exceed 0.01 wt %, B reacts with Fe in the steel to form an intermetallic compound, so that it is difficult to expect an effect of grain boundary segregation to increase the coercive force of the grain boundaries, and the formation of the secondary recrystallization of the Goss orientation grain is disturbed, thereby the magnetic properties are weakened.

### Example 3

A slab containing C: 0.051%, Si: 3.3%, Mn: 0.047%, S: 0.014%, Se: 0.016%, P: 0.035%, Sn: 0.06%, B: 0.0055% by weight and Al and N with varying contents as shown in Table 3 below, and the remainder containing Fe and other inevitable impurities was prepared.

The slab was heated to a temperature of 1150° C. and hot-rolled to a thickness of 2.6 mm. After measuring the occurrence depth of the side edge crack of the hot-rolled sheet, the hot-rolled sheet after hot-rolling was heated to a temperature of 1100° C. and then soaked for 150 seconds to perform hot-rolled sheet annealing.

Subsequently, the annealed hot-rolled steel sheet was pickled and then cold-rolled to produce a cold-rolled sheet having a thickness of 0.27 mm. The cold-rolled steel sheet was subjected to decarburization and recrystallization heat treatment by maintaining it at a temperature of 855° C. for 180 seconds in a wet, mixed gas atmosphere of hydrogen and nitrogen having a dew point temperature of 60° C.

The steel sheet was applied with MgO, which is an annealing separator, and subjected to final secondary recrystallization annealing in a type of a coil. The secondary recrystallization annealing was carried out in a mixed atmosphere of 50 vol % of nitrogen and 50 vol % of hydrogen until 1200° C., and after reaching 1200° C., the secondary recrystallization annealing was maintained in a 100 vol % of hydrogen gas atmosphere for 20 hours and then furnace cooled. Table 3 shows the average size and the number per unit area of inclusions of the steel sheet subjected to the secondary recrystallization annealing through the inclusion analysis. The magnetic flux density (B₈, 800 A/m) and the iron loss (W_{17/50}) were measured by single sheet measurement method. Table 3 shows the measurement results.

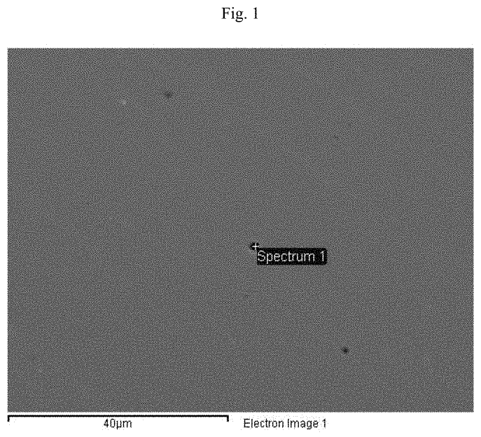

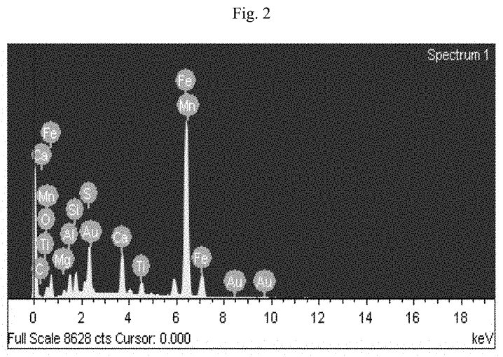

FIGS. 1 and 2 show results of analysis of inclusion and inclusion components for the Invention material 16. It may be confirmed that the amount of inclusions existing in the steel sheet is very small as shown in FIG. 1. As a result of the component analysis of the inclusions in FIG. 1, it was judged to be Ca, Ti, and Mg-based oxides, and oxides of Al₂O₃ and SiO₂3, and some MnS precipitates were also present.

TABLE 3

| | | Average particle | Number of | Magnetic | Iron loss | |
|---|---|---|---|---|---|---|
| Al | N | diameter of | inclusions | flux density | (W_{17/50}, | |
| (wt %) | (wt %) | inclusions (μm) | (pieces/mm²) | (B₈, Tesla) | W/kg) | Classification |
| 0.0014 | 0.0022 | 0.58 | 132 | 1.928 | 0.88 | Invention |
| | | | | | | material 16 |
| 0.0063 | 0.0015 | 0.65 | 269 | 1.937 | 0.87 | Invention |
| | | | | | | material 17 |
| 0.0097 | 0.0037 | 0.73 | 385 | 1.925 | 0.90 | Invention |
| | | | | | | material 18 |
| 0.0128 | 0.0033 | 1.57 | 527 | 1.911 | 0.94 | Comparative |
| | | | | | | material 9 |
| 0.0258 | 0.0057 | 1.34 | 583 | 1.905 | 0.96 | Comparative |
| | | | | | | material 10 |

As shown in Table 3, in the case of Invention material 16 to Invention material 18 in which Al was suppressed to 0.01 wt % or less and N was suppressed to 0.005 wt % or less, the number of inclusions observed in the final product was observed to be 500 pieces/mm² or less, and the magnetic flux density and iron loss were both excellent.

On the other hand, in the case of Comparative material 9 in which the content of Al exceeds 0.01 wt % and Comparative material 10 in which the content of Al exceeds 0.01 wt % and the content of N exceeds 0.005 wt %, the inclusions observed in the final product after secondary recrystallization annealing were formed in the steel sheet at an excess of 500 pieces/mm² or more, thereby the magnetic domain movement was interfered so that the iron loss was deteriorated.

As a result, the total number of such inclusions is less likely to be present in the final high-temperature annealed sheet as the content of Al and Mn added in the steelmaking step is smaller, so that the Al content in the range of 0.010 wt % or less and Mn in the range of 0.08 wt % or less may reduce the total number of inclusions in the final product, and thus produce a grain-oriented electrical steel sheet excellent in magnetic properties. In addition, it has been confirmed that the content of impurities such as Ca, Ti, and Mg need to be limited to 0.005 wt % or less, respectively, to reduce the number of inclusions in the final product to 500 pieces/mm² or less.

The present invention is not limited to the above-mentioned examples or embodiments and may be manufactured in various forms, those who have ordinary knowledge of the technical field to which the present invention belongs may understand that it may be carried out in different and concrete forms without changing the technical idea or fundamental feature of the present invention. Therefore, the above-mentioned examples or embodiments are illustrative in all aspects and not limitative.

What is claimed is:

1. A grain-oriented electrical steel sheet comprising:
Si: 1.0% to 7.0%, C: 0.005% or less (excluding 0%), P: 0.0010 to 0.1%, Sn: 0.005 to 0.2%, S: 0.0005 to 0.020%, Se: 0.0005 to 0.020% and B: 0.0001 to 0.01% by weight, and the remainder comprising Fe and other inevitable impurities.

2. The grain-oriented electrical steel sheet of claim 1, comprising 0.005 to 0.04 wt % of S and Se in a total amount.

3. The grain-oriented electrical steel sheet of claim 1, further comprising
Al: 0.010 wt % or less, Mn: 0.08 wt % or less and N: 0.005 wt % or less.

4. The grain-oriented electrical steel sheet of claim 1, further comprising 0.005 wt % or less of at least one of Ti, Mg and Ca, respectively.

5. The grain-oriented electrical steel sheet of claim 1, comprising
composite grain boundary segregation of S and Se, and composite inclusion of Fe (S, Se).

6. The grain-oriented electrical steel sheet of claim 1, comprising 0.01 to 500 pieces/mm² of inclusions comprising Al, Mn, Si, Mg, Ca, B or Ti.

7. A method for manufacturing a grain-oriented electrical steel sheet, the method comprising:
heating a slab comprising Si: 1.0 to 7.0%, C: 0.001 to 0.10%, P: 0.0010 to 0.1%, Sn: 0.005 to 0.2%, S: 0.0005 to 0.020%, Se: 0.0005 to 0.020%, and B: 0.0001 to 0.01% by weight, and the remainder comprising Fe and other inevitable impurities;
hot-rolling the slab to produce a hot-rolled sheet;
cold-rolling the hot-rolled sheet to produce a cold-rolled sheet;
primary recrystallization annealing the cold-rolled sheet; and
secondary recrystallization annealing the cold-rolled sheet which is the primary recrystallization annealed.

8. The method of claim 7, wherein,
the slab comprises 0.005 to 0.04 wt % of S and Se in a total amount.

9. The method of claim 7, wherein,
the slab further comprises Al: 0.010 wt % or less, Mn: 0.08 wt % or less and N: 0.005 wt % or less.

10. The method of claim 7, wherein,
the slab further comprises 0.005 wt % or less of at least one of Ti, Mg and Ca, respectively.

11. The method of claim 7, wherein,
a side edge crack of the hot-rolled sheet occurs 20 mm or less after the step of producing the hot-rolled sheet.

12. The method of claim 7, further comprising
a step of annealing the hot-rolled sheet after the step of producing the hot-rolled sheet.

13. The method of claim 7, wherein,
the step of cold-rolling the hot-rolled sheet to produce a cold-rolled sheet comprises a step of cold-rolling at least two times, and a step of intermediate annealing between cold-rolling.

14. The method of claim 7, wherein,
the step of secondary recrystallization annealing comprises a step of temperature-raising and a step of soaking, wherein the step of temperature-raising is performed in mixed atmosphere of nitrogen and hydrogen, and the step of soaking is performed in hydrogen atmosphere.

15. The method of claim 14, wherein,
the step of soaking is performed at a temperature of 1000 to 1250° C. for 20 hours or less.
